(19) United States
(12) Patent Application Publication
(10) Pub. No.: US 2002/0171754 A1
(43) Pub. Date: Nov. 21, 2002

(54) Digital camera with multi-illuminating source

(76) Inventors: I-Jen Lai, T.E.P.E. (TW); Pie-Yau Chien, T.E.P.E. (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/859,597

(22) Filed: May 18, 2001

(51) Int. Cl. H04N 5/222

(52) U.S. Cl. 348/371; 348/370

(57) ABSTRACT

A digital camera with a multi-illuminating source has a microprocessor connected with a flash lamp driver, a laser driver and a CCD sensor. The flash lamp driver and the laser driver are respectively connected to a flash lamp and an IR LD. The CCD sensor is further connected with a memory and a filter. The microprocessor controls the flash lamp driver and the laser driver to emit flashlight light signals or infrared light signals respectively via the flash lamp and the IR LD toward a target. A reflected light signal from the target is converted into a digital photo signal by the CCD sensor and then stored in the memory. Because the digital camera combines the flash lamp and the IR LD, the digital camera is suitable to be operated in any condition despite the surrounding light limitation.

### BACKGROUND OF THE INVENTION

1. Field of the Invention

The present invention relates to a digital camera with a multi-illuminating source, and more particularly to a digital camera that not only has a flash light illuminating source, but also has an infrared illuminating source.

2. Description of Related Art

Due to the developing technology of digital cameras, there is a tendency that the digital camera is gradually becoming as common as the conventional camera. The photograph taken by the digital camera is stored as a digital photo file, thus the digital photo file is suitable for use in in many fields. The digital photo file is often transferred to clothes and printed on many objects, such as cups, keepsakes etc. Furthermore, one of the advantages of the digital camera is that the digital photo file is able to be stored in a computer, so all photos can be compactly and pristinely kept for eternity.

Conventionally, the digital camera only has a single illuminating light source for use in low light during the day. When the flash lamp light is used, the digital camera is only suitable for a specific illuminating condition.

To overcome the shortcomings, the present invention tends to provide a digital camera with a multi-illuminating source to mitigate and obviate the aforementioned problems.

### SUMMARY OF THE INVENTION

The main objective of the invention tends to provide a digital camera with a multi-illuminating source, wherein the digital camera has an infrared illuminating source for use in an insufficient light situation, such as at night, and a flash lamp light source for use in a low light situation, such as a cloudy day.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a digital camera in accordance with the present invention;

FIG. 2 shows timing control signals of a CCD sensor, and a flash lamp light signal in accordance with the present invention;

FIG. 3 shows timing control signals of a CCD sensor, and a laser light signal in accordance with the present invention; and

FIG. 4 is a graph of transmittance versus wavelength for a filter shown in FIG. 1 in accordance with the present invention.

### DETAILED DESCRIPTION OF THE PREFERRED EMBODIMENT

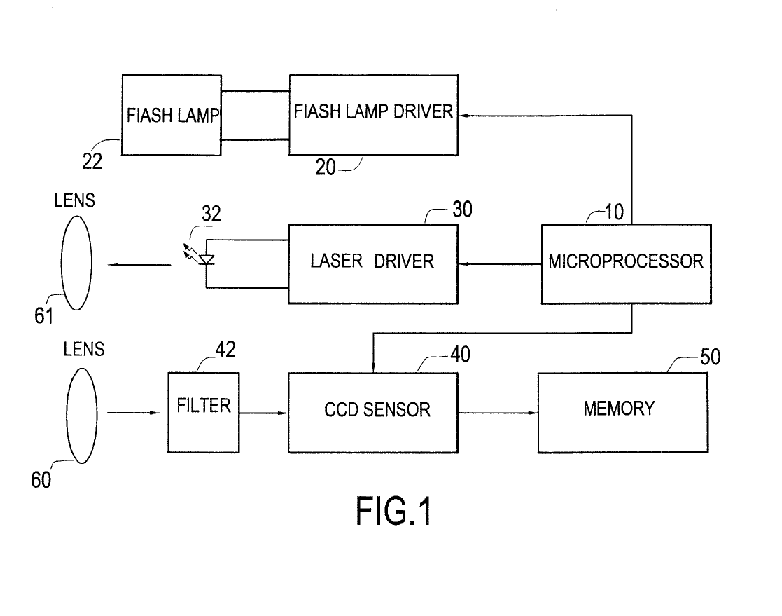

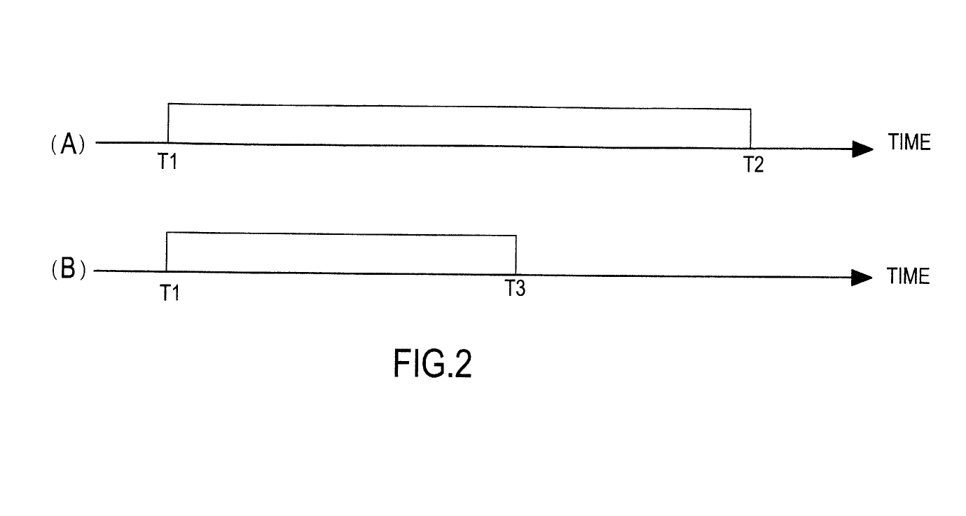

With regards to FIGS. 1 and 2, a digital camera in accordance with the present invention comprises a microprocessor (10) connected to a flash lamp driver (20), a laser driver (30) and a charge coupled device (CCD) sensor (40). The CCD sensor (40) is further connected with a filter (42) and a memory (50). The flash lamp driver (20) and the laser driver (30) are respectively connected with a flash lamp (22) and an infrared laser diode (32) (IR LD).

The digital camera disclosed in this application is able to be operated in two modes, a flash lamp illuminating mode and an infrared illuminating mode. When the surrounding light is insufficient such as at night, the digital camera is operated in the infrared illuminating mode. On the contrary, the digital camera is operated in the flash lamp illuminating mode during daytime. The detailed operation of the two modes mentioned is in the following description.

When the digital camera is operated in the flash lamp illuminating mode, the microprocessor (10) provides a trigger signal to the flash lamp driver (20), whereby the flash lamp driver (20) controls the flash lamp (22) to generate a flashlight signal toward a target. After the flashlight signal is reflected from the target, and passes through a first lens (60) and a filter (42), the reflected optical signal is converted into a digital photo signal by the CCD sensor (40) and then stored in the memory (50). The filter (42) is treated specially for receiving the visible reflected optical signal from the target with a wavelength under 700 nm.

With reference to FIG. 2, in the flash lamp illuminating light mode, the period from T1 to T2 indicated with (A) represents a sensing period of the CCD sensor (40), and the period from T1 to T3 indicated with (B) represents the period of the flashlight signal emitted by the flash lamp (22). Since a time delay exists between emitting the flashlight signal and receiving the reflected flashlight signal, the sensing period T1 to T2 is purposely designed to be a little longer than the period T1 to T3, whereby the CCD sensor (40) has enough time to convert the optical signal into the digital signal.

With reference to FIG. 1, when the digital camera is operated in the infrared illuminating mode, the microprocessor (10) provides a trigger signal to the laser driver (30), whereby the laser driver (30) controls the infrared laser diode (32) to generate a series of infrared light pulse signals with accurate time toward a target through a second lens (61). After the infrared light pulses are immediately reflected from the target, and pass through the first lens (60) and the filter (42), the reflected infrared light signals are converted into a digital photo signal by the CCD sensor (40) and then stored in the memory (50). The filter (42) also can receive the infrared signal with 890 nm wavelength. Furthermore in this invention, the infrared laser diode (32) is able to be replaced by an infrared light emitting diode (IR LED).

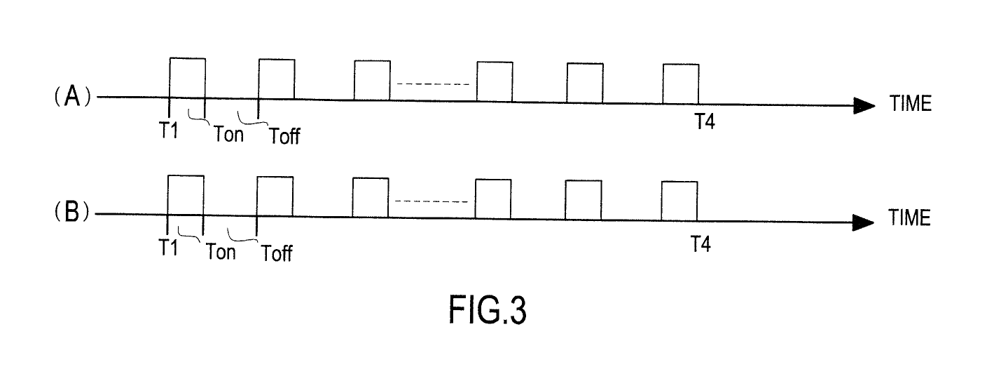

With reference to FIG. 3, in the infrared illuminating mode, the signal (A) represents the sensing period of the CCD sensor (40), and the signal (B) represents the emitted infrared light pulse signal. Because the speed of the infrared light signal is very fast, i.e., almost no time delay, the sensing period of the CCD sensor (40) is synchronized to the emitted infrared light signal.

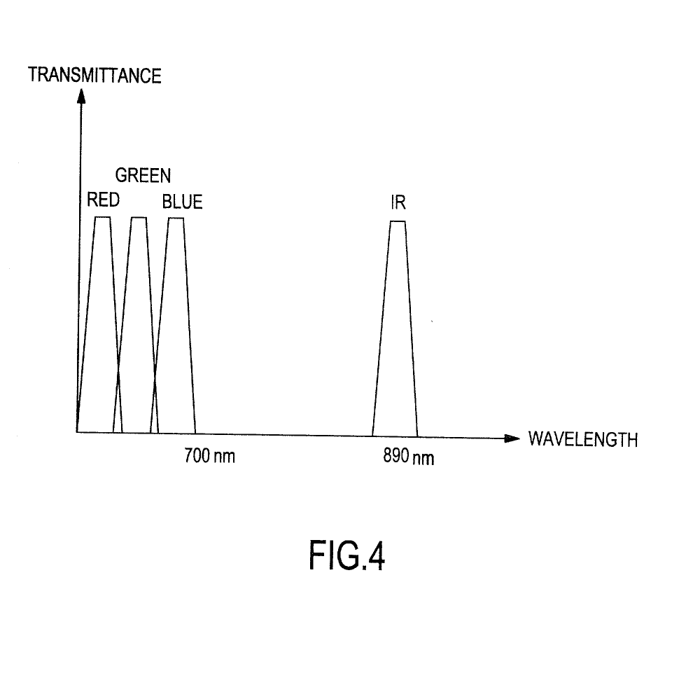

With reference to FIG. 4, the characteristic chart of the filter (42) is shown. The filter (42) is treated speially for receiving visual light with a wavelength under 700 nm and invisible infrared light with a wavelength 890 nm. The light signals with wavelengths other than 890 nm and under 700 nm are obstructed by the filter (42).

Although the present invention has been explained in relation to its preferred embodiment, it is to be understood that many other possible modifications and variations can be made without departing from the spirit and scope of the invention as hereinafter claimed.

What is claimed is:

1. A digital camera with a multi-illuminating source, the digital camera comprising:
a microprocessor for providing a trigger signal;
a flash lamp driver connected to the microprocessor for receiving the trigger signal;
a flash lamp connected to the flash lamp driver, wherein the flash lamp is controlled by the flash lamp driver to emit a flashlight signal toward a target;
a laser driver connected to the microprocessor for receiving the trigger signal;
an infrared element connected to the laser driver for emitting a series of infrared light signals toward the target;
a charge coupled sensor connected to the microprocessor for receiving a reflected signal from the target through a filter and converting the reflected signal into a digital photo signal, wherein the filter is connected to the charge coupled sensor; and
a memory connected to the charge coupled sensor for storing the digital photo signal from charge coupled sensor.

2. The digital camera with a multi-illuminating source as claimed in claim 1, wherein the infrared element is an infrared laser diode (IR LD).

3. The digital camera with a multi-illuminating source as claimed in claim 1, wherein the infrared element is an infrared light emitting diode (IR LED).
